(19) United States
(12) Patent Application Publication
(10) Pub. No.: US 2026/0172774 A1
(43) Pub. Date: Jun. 18, 2026

(54) IMPROVING AUDIO RENDERING BY EXTRACTING A FREQUENCY BAND

(71) Applicant: SAGEMCOM BROADBAND SAS, BOIS-COLOMBES (FR)

(72) Inventors: Stéphane DELPLACE, BOIS-COLOMBES (FR); Vincent SCHOTT, BOIS-COLOMBES (FR); Frédéric SODI, BOIS-COLOMBES (FR)

(21) Appl. No.: 19/418,688

(22) Filed: Dec. 12, 2025

(30) Foreign Application Priority Data
Dec. 12, 2024 (FR) FR2413953

(51) Int. Cl. H04S 7/00; H04S 3/00

(52) U.S. Cl. CPC H04S 7/307; H04S 3/008; H04S 2400/01; H04S 2400/03

(57) ABSTRACT

An audio device includes a frequency component extraction module; a selection module arranged to select at least one selected audio channel and to control the extraction module so that it extracts the frequency components only from the at least one selected audio channel; a processing module arranged to carry out at least one processing operation that results in an interchannel delay on the at least one selected audio channel, from which the frequency components have been removed, and on the at least one non-selected audio channel; and an injection module arranged to add together said frequency components on each processed audio channel.

The invention relates to the field of multichannel audio systems.

### BACKGROUND OF THE INVENTION

A set-top box (STB) is an audio-video broadcasting apparatus whose primary function is to acquire and decode an audio-video stream and to have the video signal broadcast by a television and the audio stream broadcast by the loudspeakers of the television and/or optionally by other audio playback apparatuses (soundbar, smart speakers, etc.).

Some of the latest set-top boxes include an audio device comprising one or more loudspeakers. The one or more loudspeakers can be used as part of a voice assistant function and for contributing to the implementation of a multichannel audio system that plays back the audio stream of the audio-video stream. Multichannel playback allows the sound to be rendered optimally and immersively.

Set-top boxes whose audio device allows the left (L), right (R) and centre (C) channels to be “physically” played back are known.

The audio device may also carry out a virtualisation process to create the impression that audio channels not physically present are present (albeit virtually).

This makes it possible, for example, to implement audio playback in 5.1.2 format and to obtain a more immersive sound experience.

The 5.1.2 format normally requires five main speakers (front left, front centre, front right, back left, back right), a subwoofer and two up-firing speakers, which can be placed on the ceiling or directed towards the ceiling to reflect the sound. The up-firing speakers are positioned in the “top middle” position, for example.

In the situation described here, the rear or surround channels (left surround (Lₛ) and right surround (Rₛ)) and the up-firing or top middle channels (left top middle (Lₜₘ) and right top middle (Rₜₘ)) are not physically present but are created and then virtualised. The surround and top middle channels are then downmixed on the physically present channels (L, R, C), creating the impression for the user that these channels are indeed present and thus that some of the audio content is coming from behind or from above.

Alternatively, the set-top box can be connected to other audio playback devices and interact with these devices to perform multichannel playback. These other audio playback devices are, for example, two satellite speakers which physically play back the two surround channels. In this case, only the top middle channels are virtualised.

With reference to FIG. 1, the processing chain 1 implemented by the audio device 2 of the set-top box 3 comprises an upmixer module 4, a processing module 5 performing the virtualisation, a downmixer module 6 and a low-frequency creation module 7.

Upmixing is an audio processing operation that involves converting an input audio signal having a reduced number of channels into a signal comprising a greater number of channels. The input audio signal typically comprises between two and eight audio channels. By way of example, the signal is a stereo signal having two channels L, R. The signal created is in 5.1.2, for example.

Upmixing uses algorithms to redistribute the sound elements of the original signal to the different speakers. For example, dialogue can be directed to the centre speaker, sound effects to the surround speakers and ambient sounds to the up-firing speakers.

Downmixing, on the other hand, involves reducing the number of channels of a multichannel signal.

The upmixer module 4 thus acquires input audio channels Cₑ contained in the audio stream and creates the L/R/C/Lₛ/Rₛ/Lₜₘ/Rₜₘ channels from the input audio channels Cₑ.

The processing module 5 performs the virtualisation.

The downmixer module 6 uses a matrix to carry out the matrixing of the virtualised channels Cᵥ on the physically present channels (e.g. L, R and C for the set-top box 3). By means of coefficients of a matrix M, the matrixing allows the channels input into the matrix to be multiplexed on the output channels.

The low-frequency creation module 7 extracts the low-frequency components (up to what is known as the “crossover frequency”) from the previously generated channels. Then, the low-frequency components are added together to produce the low-frequency effects (LFE) channel.

For example, the crossover frequency is set at 500 Hz such that all the frequencies below 500 Hz are extracted as low frequencies by the “crossover” filtering.

The output channels Cₛₒ are intended for playback by the multichannel audio system.

The drawback of the virtualisation operations carried out by the processing module 5 is that they result in an interchannel delay which generates a phase shift between the channels. The low frequencies phase-shifted in this way by the virtualisation are added together in the LFE channel by the low-frequency creation module 7, leading to a power loss of up to 10 dB SPL (sound pressure level—a measurement of the sound level received at one point).

Such power losses must be avoided.

Generally, the ability to adjust the frequency above which the virtualisation operations are applied avoids this problem, as action is taken directly in the processing module 5. However, this adjustment may not be available or may not allow all the low frequencies extracted by the low-frequency management module 7 to be covered, in particular in the event of a high crossover frequency imposed by the acoustic elements.

For example, the virtualisation could be applied from a maximum of 250 Hz (e.g. the virtualisation window starts at 250 Hz, which is a maximum value for this threshold; in practice, the virtualisation window could start at a frequency lower than 250 Hz), and the acoustic elements of the audio device 2 of the set-top box 3 could impose a crossover frequency of 500 Hz (e.g. the speakers suitable for playing back low frequencies are characterised by a maximum acoustic frequency of 500 Hz). In this case, the adjustment does not allow the aforementioned problem to be solved.

It is noted that this problem does not necessarily concern only virtualisation operations but, more generally, any processing operation that results in an interchannel delay. Likewise, the frequency band to which the extracted frequency components belong is not necessarily a low-frequency band.

The aim is thus to solve this power loss problem in a general context. It goes without saying that the solution selected to solve the problem must not degrade the acoustic rendering for the user.

### OBJECT OF THE INVENTION

The object of the invention is to improve the sound rendering of a multichannel audio system.

### SUMMARY OF THE INVENTION

To achieve this object, an audio device is proposed, comprising a processing chain arranged to acquire input audio channels and to produce output audio channels that are intended to be played back by a multichannel audio system, the processing chain comprising:
a module for extracting frequency components belonging to a predefined frequency band, first audio channels that originate from the input audio channels being input into said module;
a selection module arranged to select at least one audio channel, selected from among the first audio channels, and to control the extraction module so that it extracts said frequency components only from the at least one selected audio channel and not from at least one non-selected audio channel;
a processing module arranged to carry out at least one processing operation that results in an interchannel delay on the at least one selected audio channel, from which said frequency components have been removed, and on the at least one non-selected audio channel, so as to produce processed audio channels;
an injection module arranged to add together said frequency components on each processed audio channel so as to produce second audio channels intended to be used to produce the output audio channels.

The audio device thus extracts the frequency components of the predefined frequency band (for example low-frequency components) upstream of the processing module, which results in the interchannel delay, and the injection module adds together said frequency components on the processed audio channels, i.e. downstream of the processing module. The processing module therefore does not generate any phase shift on these frequency components, which can then be added together without any power loss.

However, it has been found that the audio rendering could be degraded if the frequency components of the predefined frequency band that have originated from particular channels are injected onto all the processed audio channels. In particular, when an audio channel contains a voice, re-injecting the frequency components originating from this channel onto all the channels present impairs the intelligibility of the voice and generates an echo effect. The selection module therefore allows the frequency components to be extracted only from selected channels, thereby making it possible to remedy this problem.

The audio device thus makes it possible to solve the power loss problem without degrading the audio rendering. This significantly improves the audio rendering of the multichannel audio system.

Also proposed is an audio device as described above in which the at least one audio channel selected by the selection module comprises at least one predefined audio channel statically selected by the selection module.

Also proposed is an audio device as described above in which the at least one selected audio channel comprises a left channel and a right channel, and the at least one non-selected audio channel comprises a centre channel.

Also proposed is an audio device as described above in which the processing chain is arranged to analyse audio channels present upstream of the extraction module, the at least one audio channel selected by the selection module comprising at least one channel selected on the basis of said analysis.

Also proposed is an audio device as described above in which the predefined frequency band comprises low frequencies below a predefined threshold.

Also proposed is an audio device as described above in which the processing module performs a virtualisation.

Also proposed is an audio device as described above in which the processing chain further comprises an upmixer module arranged to produce the first audio channels from the input audio channels.

Also proposed is an audio device as described above in which the processing chain further comprises a downmixer module arranged to produce third audio channels from the second audio channels, the output audio channels comprising the third audio channels.

In addition, an apparatus comprising an audio device as described above is proposed.

In addition, an apparatus as described above is proposed, the apparatus being a set-top box.

In addition, a processing method is proposed, which is carried out in the audio device as described above and comprises the steps of:
selecting at least one audio channel, selected from among the first audio channels, and controlling the extraction module so that it extracts the frequency components only from the at least one selected audio channel and not from at least one non-selected audio channel;
carrying out at least one processing operation that results in an interchannel delay on the at least one selected audio channel, from which said frequency components have been removed, and on the at least one non-selected audio channel, so as to produce processed audio channels;
adding together said frequency components on each processed audio channel so as to produce second audio channels intended to be used to produce the output audio channels.

In addition, a computer program is proposed, comprising instructions which cause the audio device of the apparatus as described above to execute the steps of the processing method as described above.

In addition, a computer-readable storage medium is proposed, on which the computer program as described above is stored.

The invention will be better understood in the light of the following description of particular, non-limiting embodiments of the invention.

### BRIEF DESCRIPTION OF THE DRAWINGS

Reference will be made to the accompanying drawings, in which:

FIG. 1 shows a processing chain of a prior-art audio device;

FIG. 2 shows the set-top box, the television and satellite speakers;

FIG. 3 shows a processing chain of an audio device according to a first embodiment of the invention;

FIG. 4 is a graph showing, in the frequency domain, curves of the signals of the LFE channel with and without low-frequency extraction;

FIG. 5 is a graph showing, in the frequency domain, the curves of the signals of the left channel at the input of the processing chain and at the output, with and without channel selection;

FIG. 6 is a figure similar to FIG. 5 but with the centre channel;

FIG. 7 is a figure similar to FIG. 5 but with the LFE channel;

FIG. 8 shows a processing chain of an audio device according to a second embodiment of the invention.

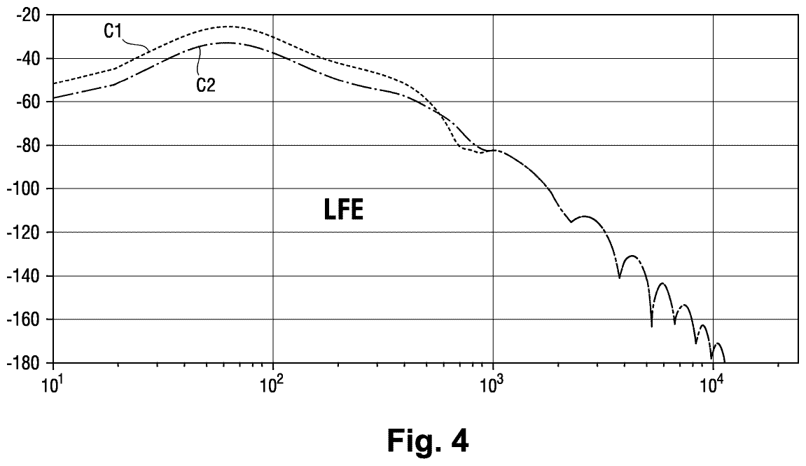

The curves in FIGS. 4 to 7 show the level of the audio channel in question on the y axis, expressed in dBFS (decibel full scale), plotted against the acoustic frequency expressed in hertz (Hz) on the x axis.

### DETAILED DESCRIPTION OF THE INVENTION

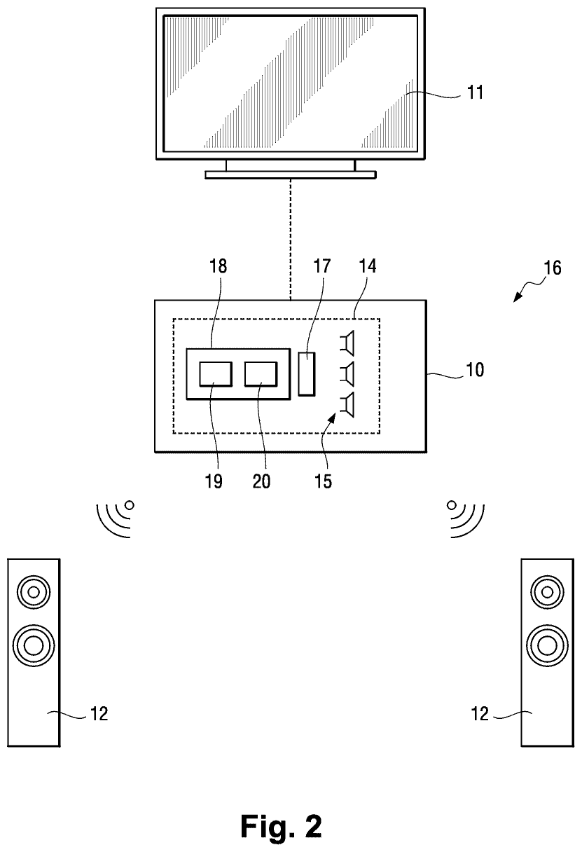

With reference to FIG. 2, the set-top box 10 (also called a TV decoder or audiovisual decoder) is connected to a television 11 and to satellite speakers 12.

The set-top box 10 is an “advanced” set-top box that includes an audio device 14 comprising a plurality of loudspeakers 15.

The audio device 14 of the set-top box 10 is integrated in a multichannel audio system 16 which, in addition to the set-top box 10, comprises the satellite speakers 12.

The set-top box 10 receives an audio-video stream and transmits the video stream to the television 11 and the audio stream to the audio devices of the audio system 16. Here, therefore, the television 11 is not used to play back the audio stream (although the invention could be implemented by also using the loudspeakers of the television 11).

The audio-video stream may come from any source, for example a broadcast network (satellite television network, internet connection, digital terrestrial television network (DTT), cable television network, etc.), another apparatus connected to the set-top box 10 (a CD, DVD or Blu-ray player, a smartphone, a tablet, etc.) or a storage medium (for example a USB stick or a memory card connected to the set-top box).

The set-top box 10 also plays the role of audio playback apparatus in the audio system 16; its loudspeakers 15 play back part of the audio stream.

The loudspeakers 15 of the audio device 14 of the set-top box 10 comprise a left loudspeaker, a right loudspeaker and a centre loudspeaker, which allow the set-top box to “physically” play back the left (L), right (R) and centre (C) channels.

The audio device 14 of the set-top box 10 also comprises audio components 17 (in particular audio amplifiers) which format the audio signals played back by the loudspeakers 15 of the set-top box 10.

The audio device 14 of the set-top box 10 also comprises a processing unit 18.

The processing unit 18 (electronic and software) comprises at least one processing component 19, for example, a “general-purpose” processor, a processor specialising in signal processing (digital signal processor, DSP), a processor specialising in artificial intelligence algorithms (neural processing unit, NPU), a microcontroller, or a programmable logic circuit, such as an FPGA (field-programmable gate array) or an ASIC (application-specific integrated circuit).

The processing unit 18 also comprises one or more memories 20 connected to or integrated in the processing component 19. At least one of these memories 20 forms a computer-readable storage medium on which at least one computer program is stored, said computer program comprising instructions which cause the processing component 19 to execute at least some steps of the processing method described below.

The processing unit 18 manages the multichannel audio playback of the audio stream by the audio system 16 and, in particular, carries out a virtualisation method to create the impression that audio channels not physically present are present (albeit virtually). The system is configured in 5.1.2, and the left top middle and right top middle channels are virtualised. Here, the left surround (L) and right surround (R) channels are played back by the speakers 12, and the left (L), right (R) and centre (C) channels are played back by the loudspeakers 15 of the set-top box 10. Here, the LFE channel is re-injected onto the different channels, but it would also be possible to have a subwoofer to play said channel back.

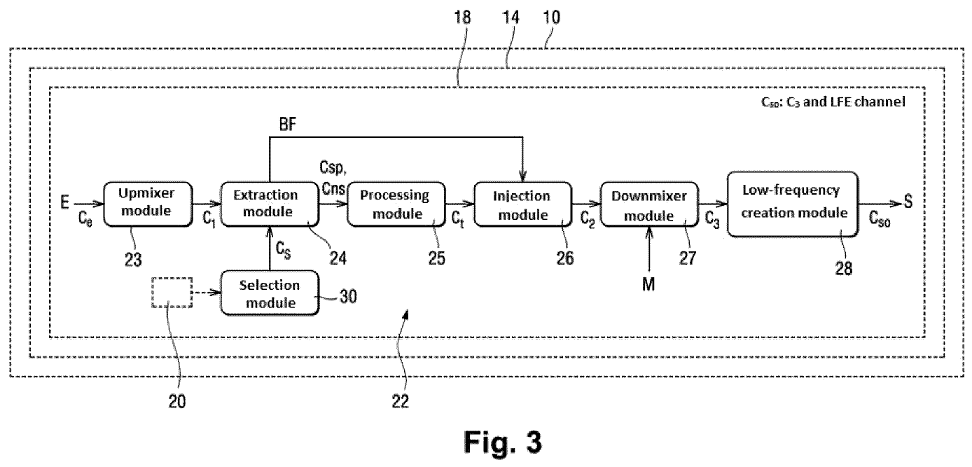

With reference to FIG. 3, the processing unit 18 implements a processing chain 22 comprising an upmixer module 23, an extraction module 24, a processing module 25, an injection module 26, a downmixer module 27 and a bass creation module 28, which produces and adds together the low-frequency components to produce the LFE channel. These modules are arranged in this order from upstream to downstream. “Upstream” means on the input side E of the processing chain 22, and “downstream” means on the output side S of the processing chain 22.

The processing chain 22 also comprises a selection module 30 that interacts with the extraction module 24.

The audio stream comprises input audio channels Cₑ, typically between two and eight input channels. In the present case, the audio stream is in stereo format and comprises two input channels Cₑ, which are the R and L channels.

The upmixer module 23 acquires the input audio channels Cₑ and creates first audio channels C₁ from the input audio channels. The first audio channels C₁ are the L/R/C/Lₛ/Rₛ/Lₜₘ/Rₜₘ channels.

The extraction module 24 extracts frequency components belonging to a predefined frequency band. The first audio channels C₁, originating from the input audio channels Cₑ, are input into the extraction module 24.

The predefined frequency band here comprises low frequencies below a predefined threshold. The frequency components extracted by the extraction module 24 are therefore the low-frequency components BF below the predefined threshold, for example between 1 Hz and the predefined threshold. Here, the predefined threshold is equal to the crossover frequency, which is equal to 500 Hz, for example.

The selection module 30 selects at least one audio channel Cₛ, selected from among the first audio channels C₁, and controls the extraction module 24 so that it extracts said frequency components only from the at least one selected audio channel Cₛ and not from at least one non-selected audio channel Cₙₛ.

Thus, extraction is not performed on all the audio channels. The benefit of this operation will be set out further below.

The processing module 25 carries out at least one processing operation that results in an interchannel delay on the at least one selected audio channel Cₛₚ, from which said frequency components have been removed, and on the at least one non-selected audio channel Cₙₛ, which thus retains said low-frequency components, so as to produce processed audio channels Cₜ. Here, the at least one processing operation comprises a virtualisation.

By way of example, the virtualisation applies a head-related transfer function to the selected audio channels Cₛₚ, from which the low-frequency components have been removed (L and R channels from which the low-frequency components have been removed), and to the non-selected audio channels Cₙₛ (C/Lₛ/Rₛ/Lₜₘ/Rₜₘ channels).

The injection module 26 adds together the low-frequency components BF on each processed audio channel Cₜ so as to produce second audio channels C₂ intended to be used to produce output channels Cₛₒ, which are in turn intended to be played back by the multichannel audio system.

The injection module 26 therefore re-injects the previously extracted low-frequency components BF onto the processed channels Cₜ.

The downmixer module 27 acquires the second audio channels C₂ and performs matrixing on the second audio channels C₂. The downmixer module 27 produces third audio channels C₃ from the second audio channels C₂. The output audio channels Cₛₒ comprise the third audio channels C₃.

The matrixing is carried out according to a predetermined distribution matrix M, which is also stored in the memory 20.

The second audio channels C₂ are therefore allocated to the physical channels L, R, C of the set-top box 10 and to the physical channels Lₛ, Rₛ of the satellite speakers 12 according to the predetermined distribution matrix M. The matrix is, for example, similar to the matrix in the Appendix, in which each value is coded on a 16-bit integer, i.e. 16385 possible values.

Alternatively, if the speakers 12 are not present, it is possible to allocate the second audio signals C₂ only to the physical channels L, R, C of the set-top box 10.

The low-frequency creation module 28 then produces the LFE channel by extracting the low frequencies (up to the crossover frequency) from the previously generated third audio channels C₃ and by adding together these low frequencies originating from said channels (e.g. adding together all the low frequencies extracted up to 500 Hz).

The output channels Cₛₒ intended to be played back by the audio system 16 therefore comprise the third audio channels C₃ and the LFE channel.

The advantages of the invention will now be explained.

First, a downgraded embodiment of the processing chain 22 of FIG. 2 that does not include the selection module 30 will be addressed.

In this case, the extraction module 24 extracts all the low-frequency components (below 500 Hz) from all the channels L, R, C, Lₛ, Rₛ, Lₜₘ, Rₜₘ. This extraction is carried out indiscriminately for all the channels, including the C channel. The result is a set of filtered channels designated by L′, R′, C′, L′ₛ, R′ₛ, L′ₜₘ, R′ₜₘ.

The processing module 25 performs the virtualisation on all these channels.

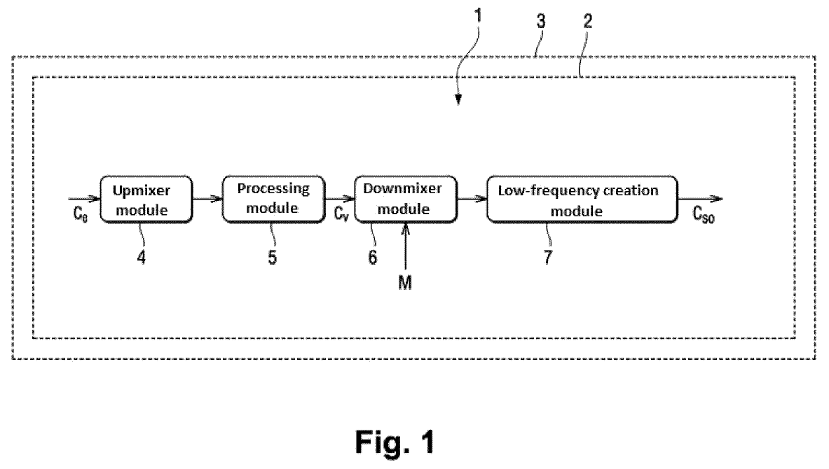

All the low-frequency components BF are therefore protected from the phase shifts linked to the virtualisation, and the power level is not impacted. The audio device 14 makes it possible to solve the power reduction problem encountered in the prior art corresponding to FIG. 1 owing to the interchannel delay, which generates a phase shift between the channels.

It can be seen in FIG. 4 that the amplitude in the frequency domain of the curve C1 corresponding to the LFE channel at the output of the processing chain 22 is greater than the amplitude of the curve C2 corresponding to the LFE channel at the output of the processing chain 1. The improvement for this channel is very clear.

However, a problem arises if a source has more than two channels.

It is known that the C channel is mainly dedicated to human voices. The low-frequency components BF from the C channel that are extracted by the extraction module 24 therefore comprise low-frequency components of the human voices.

Therefore, if the injection module 26 were to re-inject these low-frequency components onto all the channels present, the low-frequency components of the human voices would be re-injected onto all the channels. Re-injecting the low-frequency components of the human voices onto all the channels present degrades the audio rendering, impairs the intelligibility of the voice and generates an unpleasant echo effect for the user. This echo effect is due to the fact that the user is given the impression that the human voices are coming from a plurality of audio sources, because the low-frequency components of the human voices are present on all the physically present channels, thus creating the impression of a multiplicity of audio sources for the “low-frequency” playback of the human voices. Thus, the low-frequency part of the voice is broadcast on all the channels, not only on the C channel.

Where signals are rendered by heterogeneous speakers, the low-frequency part of the voice would then be processed with a different tone or even a different sound level.

Likewise, a similar problem occurs for the Lₛ/Rₛ channels whose low frequencies are broadcast on the L, R and C channels, thus shattering the multichannel effect. For example, a “rumbling” normally rendered on the Lₛ channel is heard by the user on all the channels.

Thus, even though the audio rendering is significantly improved over the prior art, the user experience is degraded and the played-back signal is distorted by comparison with the original intention of the content creator.

Using the selection module 30 solves the above-described problem.

Specifically, owing to the selection module 30, the low frequencies are extracted selectively in the sense that they are only extracted on a subset of channels (e.g. L and R) selected by the selection module 30.

Here, for example, the selection module 30 excludes the C channel dedicated to the human voices and/or the Lₛ/Rₛ channels so that the low-frequency components of the “excluded” channels (e.g. C; Lₛ/Rₛ) are not present on the other channels (e.g. L and R) when the bass is re-injected.

Here, the at least one audio channel Cₛ selected by the selection module 30 comprises at least one predefined audio channel statically selected by the selection module 30.

For example, the selection module 30 selects only the audio channels L, R on which the extraction module 24 is to extract the low-frequency components.

The selected audio channel(s) Cₛ is/are entered in advance into a static configuration file stored in the memory 20 of the processing unit 18. These audio channels can also be entered directly by the user (i.e. user choice). For example, a mask is used to select the audio channels in .json format:
{bass extraction channel mask:[true, true, false, false, false, false, false]}

In this example, it is noted that:
the audio channels L and R are considered for extracting the low-frequency components (selected channels): “true”; and
the audio channels C, LFE, Lₛ, Rₛ, Lₜₘ, Rₜₘ are not considered for bass extraction (non-selected channels): “false”.

The effect of this selective extraction is that the audio rendering is improved, in particular by enhancing the intelligibility of the human voices in the broadcast audio stream and by limiting echoes while preserving the multichannel effect.

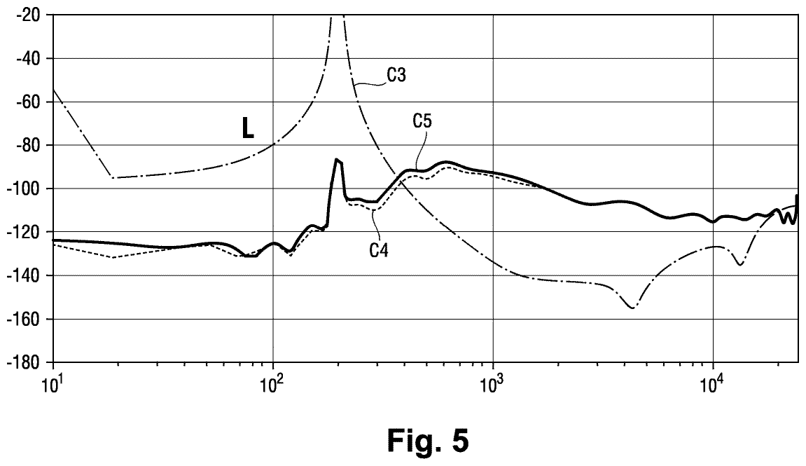

In FIGS. 5 to 7, the input signal is a 5.1 stream having a 100 Hz component on the C channel and a 200 Hz component on the L channel.

FIG. 5 shows the curve C3 of the left channel at the input of the chain 22 (on which the 200 Hz component can be discerned), the curve C4 of the left channel at the output of the chain 22 without the selection module 30, and the curve C5 of the left channel at the output of the chain 22 with the selection module 30.

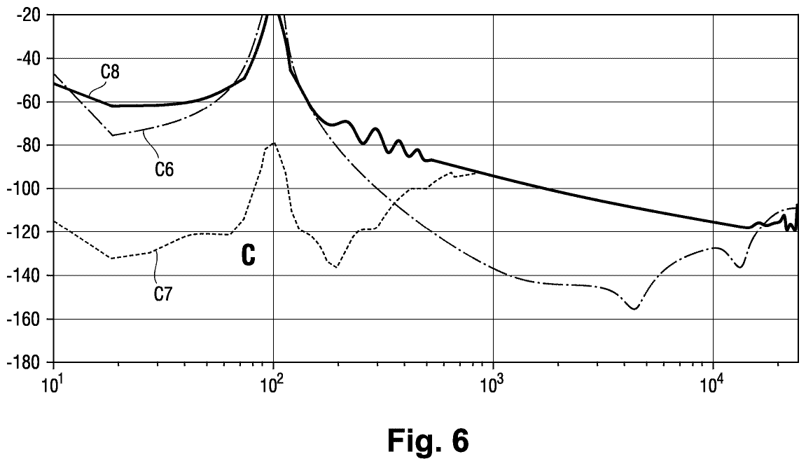

FIG. 6 shows the curve C6 of the centre channel at the input of the chain 22 (on which the 100 Hz component can be discerned), the curve C7 of the centre channel at the output of the chain 22 without the selection module 30, and the curve C8 of the centre channel at the output of the chain 22 with the selection module 30.

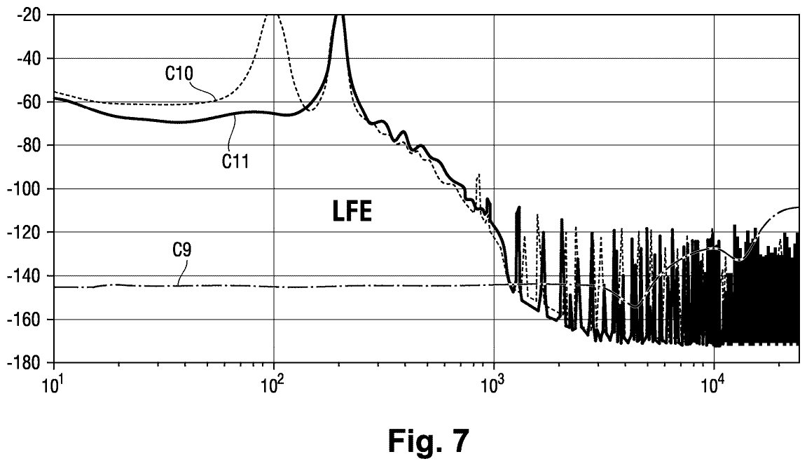

FIG. 7 shows the curve C9 of the LFE channel at the input of the chain 22, the curve C10 of the LFE channel at the output of the chain 22 without the selection module 30, and the curve C11 of the LFE channel at the output of the chain with the selection module 30.

The selection module 30 has not selected the C channel, and the 100 Hz component is not present on the curve C11 whereas the 200 Hz component from the L channel is present.

Thus, the measurement results clearly show that owing to the invention, it has been possible to entirely exclude the low-frequency component of the C channel from the LFE channel.

It goes without saying that the invention is not limited to the described embodiments but covers any variant falling under the scope of the invention as defined by the claims.

The processing operation that results in an interchannel delay, said operation being carried out by the processing module, is not necessarily a virtualisation. It could be filtering or the creation of an effect (reverberation, for example).

The predefined frequency band to which the frequency components extracted by the extraction module belong is not necessarily a low-frequency band. It could, for example, be a band between 3 kHz and 4 kHz.

The processing chain does not necessarily comprise upmixer and downmixer modules.

It has been described herein that the audio channel(s) selected by the selection module is/are predefined channels statically selected by the selection module. However, the processing chain could analyse audio channels present upstream of the extraction module, with the at least one audio channel selected by the selection module then being selected on the basis of said analysis. By way of example, the upstream audio channels are the input audio channels or the first audio channels. The analysis performed, for example, by the selection module may involve detecting a predetermined sound, defined, for example, by a particular level in a particular frequency band. The selection module can also take the current configurations of the upmixer module and/or the downmixer module as the basis for selecting the selected audio channel(s) from which the frequency components are extracted. For example, if the downmix in progress is in 3.1, the Lₛ and Rₛ channels could be selected and therefore taken into account for the bass extraction.

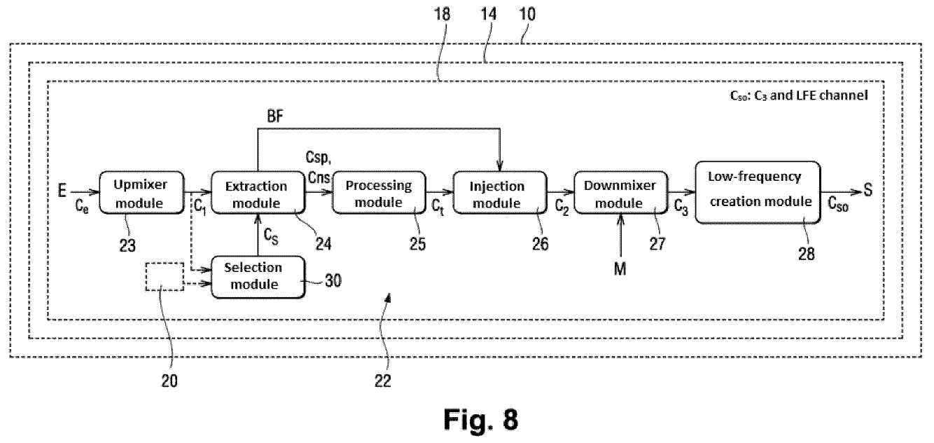

With reference to FIG. 8, in a second particular embodiment referred to as a “hybrid-selection” embodiment, the selection module 30 is configured to statically select a first subset of channels as described above (thus, for example, by accessing a configuration file stored in the memory 20) jointly with a second subset of channels on the basis of the analysis performed on channels (e.g. the first audio channels C1) upstream of the extraction module as described above.

A “subset of channels” requires there to be one or more channels.

The advantage of this hybrid channel-selection mode is real-time adaptation to a wide variety of audio formats while ensuring immersive sound rendering of excellent quality. In particular, a good balance can be achieved between processing speed (by limiting the number of channels to be analysed) and adaptability to different audio configurations.

### Appendix

### Distribution Matrix:

| | | Output | | | | | |
|---|---|---|---|---|---|---|---|
| | | L | R | C | LFE | Ls | Rs |
| Input | L | 16384 | 0 | 0 | 0 | 0 | 0 |
| | R | 0 | 16384 | 0 | 0 | 0 | 0 |
| | C | 0 | 0 | 16384 | 0 | 0 | 0 |
| | LFE | 0 | 0 | 0 | 0 | 0 | 0 |
| | Ls | 0 | 0 | 0 | 0 | 16384 | 0 |
| | Rs | 0 | 0 | 0 | 0 | 0 | 16384 |
| | Tls | 16384 | 0 | 0 | 0 | 0 | 0 |
| | Trs | 0 | 16384 | 0 | 0 | 0 | 0 |

1. An audio device comprising a processing chain arranged to acquire input audio channels and to produce output audio channels that are intended to be played back by a multichannel audio system, the processing chain comprising:
a module for extracting frequency components belonging to a predefined frequency band, first audio channels that originate from the input audio channels being input into said module;
a selection module arranged to select at least one audio channel, selected from among the first audio channels, and to control the extraction module so that it extracts said frequency components only from the at least one selected audio channel and not from at least one non-selected audio channel;
a processing module arranged to carry out at least one processing operation that results in an interchannel delay on the at least one selected audio channel, from which said frequency components have been removed, and on the at least one non-selected audio channel, so as to produce processed audio channels; and
an injection module arranged to add together said frequency components on each processed audio channel so as to produce second audio channels intended to be used to produce the output audio channels.

2. The audio device according to claim 1, wherein the at least one audio channel selected by the selection module comprises at least one predefined audio channel statically selected by the selection module.

3. The audio device according to claim 2, wherein the at least one selected audio channel comprises a left channel and a right channel, and the at least one non-selected audio channel comprises a centre channel.

4. The audio device according to claim 1, the processing chain being arranged to analyse audio channels present upstream of the extraction module, the at least one audio channel selected by the selection module comprising at least one channel selected on the basis of said analysis.

5. The audio device according to claim 1, wherein the predefined frequency band comprises low frequencies below a predefined threshold.

6. The audio device according to claim 1, wherein the processing module performs a virtualisation.

7. The audio device according to claim 1, the processing chain further comprising an upmixer module arranged to produce the first audio channels from the input audio channels.

8. The audio device according to claim 1, the processing chain further comprising a downmixer module arranged to produce third audio channels from the second audio channels, the output audio channels comprising the third audio channels.

9. An apparatus comprising an audio device according to claim 1.

10. The apparatus according to claim 9, the apparatus being a set-top box.

11. A processing method carried out in the audio device according to claim 1 and comprising the steps of:
selecting at least one audio channel, selected from among the first audio channels, and controlling the extraction module so that it extracts the frequency components only from the at least one selected audio channel and not from at least one non-selected audio channel;
carrying out at least one processing operation that results in an interchannel delay on the at least one selected audio channel, from which said frequency components have been removed, and on the at least one non-selected audio channel, so as to produce processed audio channels; and
adding together said frequency components on each processed audio channel so as to produce second audio channels intended to be used to produce the output audio channels.

12. A computer program comprising program code instructions for executing the steps of the method according to claim 11 when said program is executed on a computer.

13. A non-transitory, computer-readable storage medium storing a computer program comprising program code instructions for executing the method according to claim 11 when said program is executed on a computer.
